(19) United States
(12) Patent Application Publication
(10) Pub. No.: US 2010/0328612 A1
(43) Pub. Date: Dec. 30, 2010

(54) System and method for three-dimensional (3D) projection

(75) Inventors: Mark J. Huber, Burbank, CA (US); William Gibbens Redmann, Glendale, CA (US); Jed Harmsen, Los Angeles, CA (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/802,873

(22) Filed: Jun. 17, 2010

Related U.S. Application Data
(60) Provisional application No. 61/269,084, filed on Jun. 19, 2009.
(60) Provisional application No. 61/229,715, filed on Jul. 29, 2009.

(51) Int. Cl. G03B 21/16; G02B 27/26

(52) U.S. Cl. 353/8; 353/121

(57) ABSTRACT

A system and method for use in projecting stereoscopic images for three-dimensional presentation are disclosed. The system includes a dual-lens configuration for imparting different circular polarizations to two sets of images such that one set of images has a polarization orientation orthogonal to that of the other set of images. The dual-lens system includes at least one component for enhancing heat transfer among various elements in the system.

### CROSS-REFERENCE TO RELATED APPLICATIONS

This application claims priority to U.S. Provisional Application Ser. No. 61/269,084, “Improved Over-Under Lens for Three-Dimensional Projection” filed on Jun. 19, 2009; U.S. Provisional Application Ser. No. 61/229,715, “Lens System for 3D Projection” filed on Jul. 29, 2009; and to PCT Application No. PCT/US09/006557, “Improved Over-Under Lens for Three-Dimensional Projection” filed on Dec. 15, 2009; all of which are herein incorporated by reference in their entirety.

### TECHNICAL FIELD

The present invention relates to a lens system and method for projecting images for three-dimensional (3D) presentation.

### BACKGROUND

Movies that display images in three dimensions have gained popularity with increasing availability of 3D digital cinema projection systems. However, the rate of rollout of digital cinema systems is not sufficient to keep up with demand, especially in view of the high cost associated with retrofitting existing movie theaters.

Although many technical difficulties were encountered with earlier 3D film-based systems, including mis-configuration, low brightness, and discoloration of the picture, these systems are considerably less expensive than their digital counterparts. In the 1980's, a wave of 3D films were shown in the US and elsewhere, making use of a dual-lens and filter configuration designed and patented by Chris Condon (U.S. Pat. No. 4,464,028). Other improvements to Condon were proposed, such as by Lipton in U.S. Pat. No. 5,481,321. Subject matter in both patents are herein incorporated by reference in their entirety. An ongoing need exists for improved 3D projection systems, both for film-based and digital systems.

### SUMMARY OF THE INVENTION

Embodiments according to present principles provide an improved system and method for projecting images for 3D presentations, by improving heat transfer among components in a lens system.

One embodiment provides a system for transmitting stereoscopic images for three-dimensional (3D) projection, which includes a lens body surrounding a first lens assembly and a second lens assembly, the first lens assembly configured for projecting a first image of a stereoscopic image pair and the second lens assembly configured for projecting a second image of the stereoscopic image pair. At least one of the first lens assembly and the second lens assembly includes a lens element, a linear polarizer, a quarter-wave plate, and at least one material layer between the linear polarizer and the quarter-wave plate for removing heat from the linear polarizer.

Another embodiment provides a method for transmitting stereoscopic images for three-dimensional (3D) projection, which includes directing a first set of images through a first lens assembly that includes at least a first linear polarizer, a first quarter-wave plate, and at least a first material layer between the first linear polarizer and the first quarter-wave plate for removing heat from the first linear polarizer; directing a second set of images through a second lens assembly that includes at least a second linear polarizer, a second quarter-wave plate, and at least a second material layer between the second linear polarizer and the second quarter-wave plate for removing heat from the second linear polarizer; configuring the first linear polarizer and the first quarter-wave plate to impart a first circular polarization orientation to the first set of images; and configuring the second linear polarizer and the second quarter-wave plate to impart a second circular polarization orientation to the second set of images.

### BRIEF DESCRIPTION OF THE DRAWINGS

The teachings of the present invention can be readily understood by considering the following detailed description in conjunction with the accompanying drawings, in which:

FIG. 1 illustrates a stereoscopic projection system with a dual-lens configuration;

FIG. 2 is a side-view cross-section of a conventional stereoscopic projection lens system;

FIG. 3A is a side-view cross-section of a stereoscopic projection lens system according to one embodiment of the present principles;

FIG. 3B illustrates one embodiment of the optical elements in the lens system of FIG. 3A;

FIG. 4 is a side-view cross-section of a stereoscopic projection lens system according to another embodiment of the present principles; and

FIG. 5 is a side-view cross-section of a stereoscopic projection lens system according to yet another embodiment of the present principles.

To facilitate understanding, identical reference numerals have been used, where possible, to designate identical elements that are common to the figures. The drawings are not to scale, and one or more features may be expanded or reduced for clarity.

### DETAILED DESCRIPTION

Existing projection systems include a single, standard, 2D film projector having a dual lens configuration, e.g., in an “over and under” arrangement, in which an upper lens is used for projecting images for viewing by one eye, and a lower lens is used for projecting images for viewing by the other eye (with the right- and left-eye images for a particular scene or frame forming a stereoscopic image pair). Each of the upper and lower lenses also includes at least one filter, which encodes the corresponding left- and right-eye images so that when projected on a screen, an audience wearing glasses with appropriate viewing filters will perceive the left-eye image in their left eyes, and the right-eye image in their right eyes. This is further discussed below as background to facilitate description of the present invention.

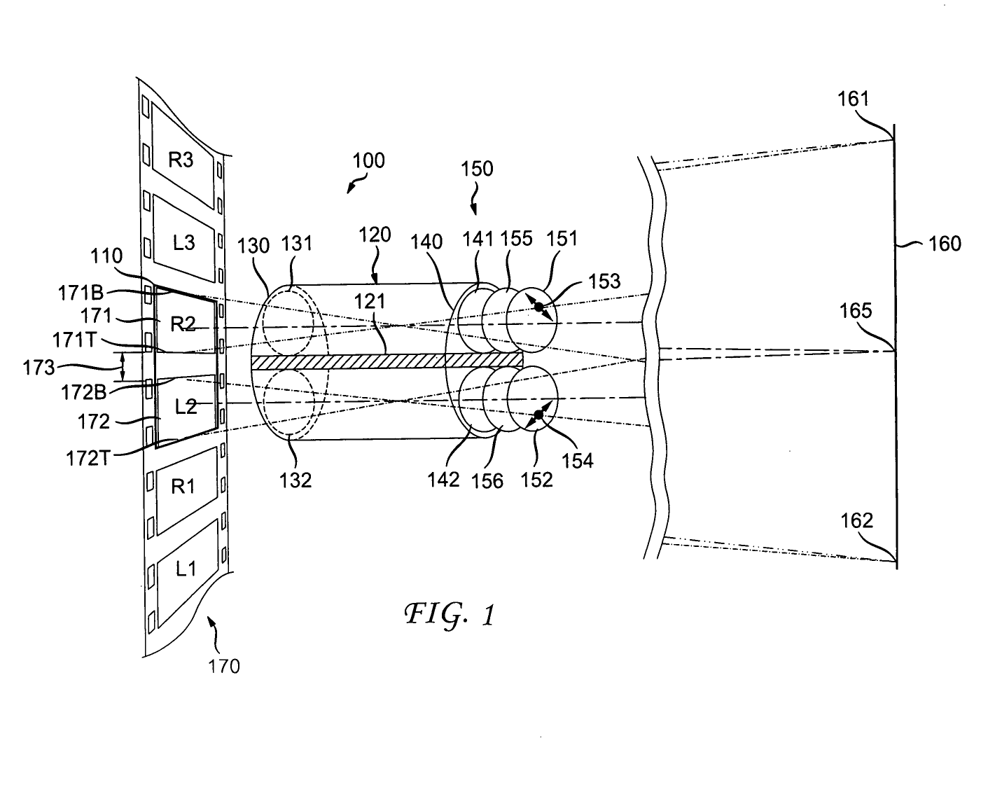

FIG. 1 shows a conventional dual-lens projection system (e.g., in an over-under configuration for a side view, or a side-by-side configuration for a top view) suitable for use in projecting stereoscopic images for 3D presentation. The projection system has a dual-lens system 100 in front of a film gate that includes aperture 110 in an aperture plate (of which only the inner edge of the aperture plate is shown for clarity) An over-under film 170 is provided between the aperture 110 and an illuminator (not shown) that includes a light source and condenser optics. Right- and left-eye images 171 and 172 on the film 170, which form a stereoscopic image pair, are separated by an intra-frame gap 173. They are framed within the aperture 110 and are simultaneously illuminated by light from the illuminator, and projected by dual-lens system 100 onto a screen 160. All other images such as images L1, R1, L3 and R3 on film 170 are not projected or visible on the screen because they are covered by the opaque portion of the aperture plate.

Dual-lens system 100 includes a lens body or housing 120 whose interior is divided into two portions (and commonly, bisected) by septum 121, which prevents stray light from crossing between the two portions of the lens system 100. Projection lens system 100 has an input end 130 directed towards aperture 110 and an output end 140 directed towards the projection screen 160. At input end 130, a first entrance (objective) lens 131, located above septum 121, is used for projection of right-eye images R2, such as image 171. A second entrance (objective) lens 132, located below septum 121, is used for projection of left-eye images L2, such as image 172. As shown in FIG. 1, film 170 is positioned in the film gate with its images 171 and 172 upside down so that they would appear right-side up when projected onto screen 160. At output end 140, a first exit lens 141 (for right-eye images) lies above septum 121 and a second exit lens 142 (for left-eye images) lies below septum 121. Other lens elements and aperture stops internal to each half of dual lens system 100 are not shown, for clarity.

By industry convention, and used throughout this discussion, right-eye images are referred to as being projected through the upper portion of lens system 100. However, other configurations are also acceptable, e.g., with right-eye images being projected through the lower portion of lens system 100. Furthermore, the two portions of lens system 100 can be configured as side-by-side (instead of over-and-under), in which case, the right- and left-eye images would be arranged side-by-side on the film.

The lens system 100 includes a linear polarizer module 150, as taught in U.S. Pat. No. 4,464,028 issued to Condon. The polarizer module 150 includes absorptive linear polarizing filters 151 and 152, having orthogonally oriented axes of polarization 153 and 154, respectively. Each axis of polarization 153 and 154 defines the orientation of the plane of the electric field that is passed by the polarizer, the s-wave. Since the performance of polarizers would deteriorate with long term exposure to ultra-violet (UV) radiation, e.g., resulting in discoloration and loss of polarizing properties, UV-blocking filters 155 and 156 are used to limit the exposure of respective linear polarizers 151 and 152 to UV. The top and bottom halves of lens system 100 are aligned with adjustments (not shown) to superimpose the left-eye and the right-eye images on the projection screen 160.

When the lens system 100 is properly aligned, the center of each of the left- and right-eye images would be projected at the center 165 of the screen 160. The tops 171T and 172T of images 171 and 172 would substantially coincide at top 161 of screen 160, and the bottoms 171B and 172B of images 171 and 172 would substantially coincide at the bottom 162 of screen 160. Since the left- and right-eye images projected onto screen 160 are encoded with respective polarizations of the projected light, the screen 160 must preserve the polarizations, i.e., polarizations of the projecting light remain unchanged after reflecting off the screen. For this reason, screen 160 is commonly a silver screen.

To view the stereoscopic images projected through linear polarization module 150 of lens system 100, individual viewers in the audience must wear glasses (not shown) with separate left- and right-eye polarized filters (may be referred to as viewing polarizers or filters) that have polarization orientations matching those of the projection polarizers 151 and 152, respectively. For example, if the right-eye polarizer 151 is vertically polarized, the right-eye viewing polarizer should also be vertically polarized, which would allow viewing of the right-eye image while blocking the left-eye image (which is horizontally polarized). The left-eye viewing polarizer should be horizontally polarized to allow viewing of the left-eye image only.

Alternatively, if the polarization axis 153 of right-eye polarizer 151 lies along a diagonal, e.g., 45 degrees clockwise from vertical when facing the screen, then the orientation of the right-eye viewing polarizer should also lie along the same diagonal as polarization axis 153. The axis 154 of the polarizer 152 for left-eye image projection will be orthogonal to that of axis 153, which in this example is 45 degrees counterclockwise from vertical when facing the screen. The viewing polarizer for the left-eye image will have the same polarization orientation to allow passage of the left-eye image while blocking the right-eye image.

However, the use of linear polarizers for image projection and viewing presents a common problem of light leakage (e.g., right-eye image being seen through the left-eye viewing polarizer, and vice versa), which occurs when the polarization orientations of the viewing glasses are not well-aligned with those of the respective stereoscopic images. This can happen, for example, due to a viewer's movement, e.g., tilting his head.

Circular polarizers, which are relatively immune to such light leakage, are often preferred in theatrical movie venues. An apparatus incorporating circular polarizers for use in projecting stereoscopic images for 3D presentation is described in a commonly-owned PCT patent application by Huber et al., PCT/US09/006557, “Improved Over-Under Lens for Three-Dimensional Projection” filed on Dec. 15, 2009. Similar to that described in FIG. 1, the apparatus in Huber et al. uses a dual-lens configuration, in which an upper lens is used for projecting a first set of images, e.g., right-eye images, and a lower lens is used for projecting a second set of images, e.g., left-eye images. However, instead of using linear polarizers for encoding the images, Huber et al. teaches the use of circular polarizers to project respective images of a stereoscopic pair are with circularly polarized light, e.g., clockwise and counter-clockwise polarization, respectively.

Another problem encountered in projection lens system is that the polarizing filters (e.g., linear or circular polarizers) tend to overheat from absorption of light, which can lead to premature failure, necessitating replacement of the lens system components.

This problem becomes more severe when used in conjunction with a film projector having a relatively high power projection lamp (e.g., greater than 4 kW) or during occasional mishandlings even with a smaller lamp (e.g., about 3 kW), the radiosity (watts per square meter of electromagnetic radiation, including infrared, ultraviolet, and visible light) through the polarizing filter can be so great as to cause the polarizer and other elements to melt or otherwise fail. This is particularly common in larger theaters or when a projectionist attempts to produce a brighter image. This failure can also occur when the projection lens is moved to the extreme of travel towards the film gate, which can result in an image of the projection lamp's plasma ball forming at or in close proximity to the polarizing filter.

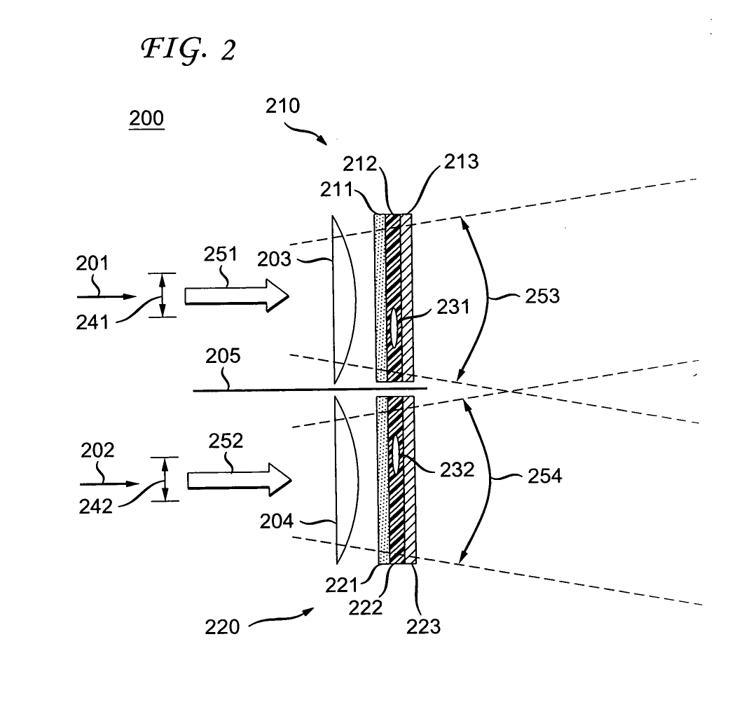

This overheating problem is further illustrated in FIG. 2, which shows a portion of a stereoscopic projection system, which includes a dual-lens system 200 having a first half or lens assembly 201 for projecting right-eye images, and a second half or lens assembly 202, for projecting left-eye images, with the two halves 201 and 202 being separated by septum 205. Other components such as an illuminator, condenser optics, shutter, film gate, film, and projection screen are not shown. Also not shown is the body or housing of lens system 200, which is typically made of metal, and has an exterior that is cylindrically shaped. The interior is machined out to accommodate various lens elements, some of which are shown, e.g., elements 203 and 204, and filter stacks 210 and 220. The body of lens system 200 may have one or many parts (e.g., as a single unit or different components coupled together) and may provide adjustments for aligning the right- and left-eye projected images.

In the first lens assembly 201, light rays 251 from an illuminator are used for projecting right-eye images, and are directed towards the screen (not shown, but to the right of lens assembly 201) as envelop 253. The first lens assembly 201 typically includes many lens elements, of which element 203 is the closest to the screen. Envelop 253 corresponds to a volume (only a part of which is shown in FIG. 2) defined by the illumination light that passes through the lens assembly 201. This volume is bounded at one end by an aperture stop 241 of the first lens assembly 201 (aperture stop is located between the entrance and exit lenses of lens assembly 201), and by the screen at the other end. When the projection system is properly configured, right-eye images are projected at the screen by rays 251.

Likewise, in the second lens assembly 202, light rays 208 are used for projecting left-eye images, and are directed towards the screen and as envelop 254. The lens assembly 202 typically includes lens elements substantially similar to those of lens assembly 201, of which element 204 is closest to the screen. Envelop 254 is bounded by an aperture stop 242 (located between the entrance and exit lenses of lens assembly 202) at one end and the screen at the other end. When the projection system is properly configured, left-eye images are projected at the screen by rays 202, substantially overlaying the corresponding right-eye images.

When the projection system is properly configured (e.g., light from the illuminator is focused by the condenser optics at the plane of the aperture stops), rays 251 and rays 252 will have their narrowest cross-sections at the respective aperture stops 241 and 242. Furthermore, when properly adjusted, an image of the illuminator (e.g., a plasma lamp arc, not shown) will be formed by the condenser optics (also not shown) at these aperture stops, and the region of highest density of radiant flux (watts of electromagnetic radiation, including infrared, ultraviolet, and visible light) will also be located at the aperture stops. However, since there are two optical axes for lens system 200, but typically only one axis for the condenser optics, the hot-spots (regions at which the radiant flux of the projector are most concentrated) at the aperture stops 241 and 242 will be located off-centered, more towards the direction of septum 205.

After passing through aperture stops 241 and 242, light rays 251 and 252 diverge, defining respective volumes 253 and 254. The radiant flux of rays 251 and 252 become correspondingly less dense as they expand through volumes 253 and 254.

In the prior art, a first filter 212 is provided near the exit of first lens assembly 201 to encode the light rays 251 projecting the right-eye image, and a second filter 222 is provided near the exit of second lens assembly 202 to encode the light rays 252 for projecting the left-eye image. For example, the first filter may be a polarizer, e.g., a linear polarizer (similar to polarizer 151 of FIG. 1) in a particular orientation, and the second filter is another linear polarizer (similar to polarizer 152) but with a polarization orientation orthogonal to that of the first filter.

In Condon (U.S. Pat. No. 4,464,028), two additional filters 211, 221, specifically, UV-blocking filters, are provided between respective element 203, 204 and corresponding linear polarizers 212, 222.

In Huber et al. (op cit.), circular polarizer stacks 210 and 220 are used, each of which includes respective protective glass filter 211 or 221; linear polarizer 212 or 222; quarter-wave plate 213 or 223 made of birefringent material; and an additional protective glass (not shown, provided on either or both faces of each of stacks 210 and 220). In one embodiment, the linear polarizers 212 and 222 are absorptive polarizers made of a plastic material, e.g., polyethylene terephthalate (PET). In some cases, the polarizer can be a lamination of polarizing membrane (e.g., made of PET, or PVA, polyvinyl alcohol with an iodine doping) with one or more support layers that are more resistant to scratch and humidity. Although not required, the support layer can also be made of a plastic material. In circular polarizer stack 210, the fast axis of quarter-wave plate 213 is oriented at 45° clockwise (when facing the screen) from the axis of polarization of linear polarizer 212, thus producing light with a right-handed (also called clockwise) circular polarization. In circular polarizer stack 220, the fast axis of quarter-wave plate 223 is oriented at 45° counter-clockwise (when facing the screen) from the axis of polarization of linear polarizer 222, thus producing light with a left-handed (also called counter-clockwise) circular polarization. Since each of the right- and left-eye images are projected with right-handed and left-handed circular polarization respectively, the audience's 3D glasses can employ appropriate circular polarizers (or viewing filters) to ensure that each eye sees only the appropriate image to create the stereoscopic effect.

When absorptive type of polarizers are used for linear polarizers 212 and 222, respective portions of light rays 251 and 252 are absorbed (i.e., the portion having a polarization orientation that is orthogonal to the orientation for the polarizer) and converted into heat, resulting in the formation of hot spots 231 and 232, corresponding to the volumes within polarizers 212 and 222 respectively, having the highest radiant flux.

If the illuminator is providing sufficient radiant flux, the temperature of hot spots 231 and 232 can become so large as to cause irreversible damage to the linear polarizers 212 and 222, or any of the other elements in stacks 210 and 220. This can also occur if lens system 200 is moved towards the left, and the illuminator's light is focused to the right of aperture stops 241 and 242, resulting in increased density of radiant flux at hot spots 231 and 232.

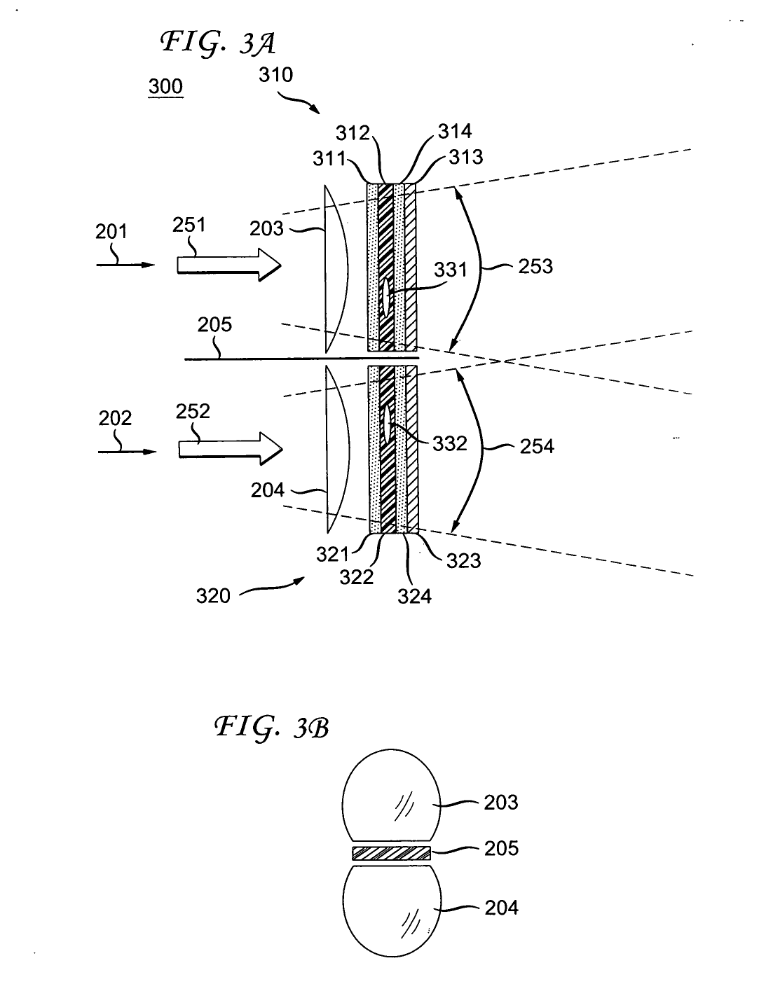

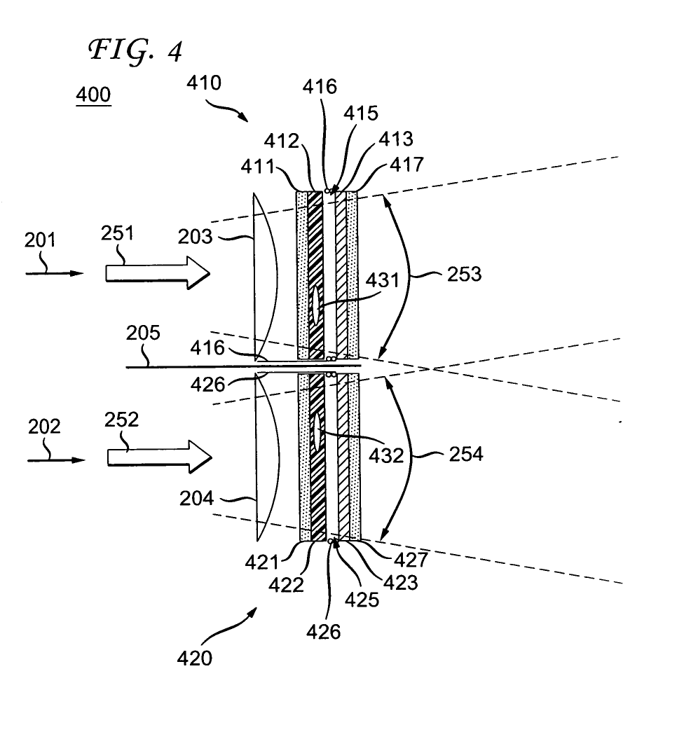

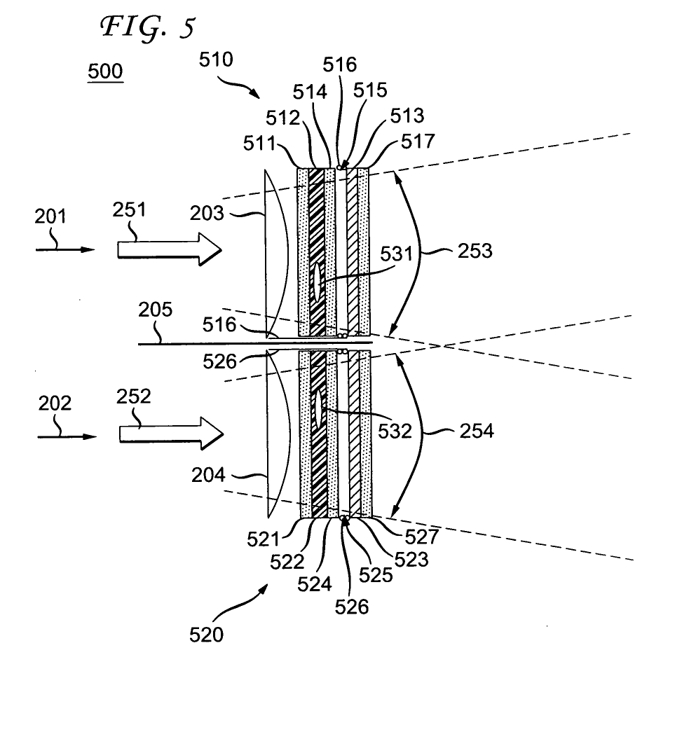

FIG. 3A shows lens system 300 with improved right- and left-eye circular polarizer stacks 310 and 320, each of which includes, respectively, a protective glass cover 311 or 321; a linear polarizer 312 or 322; a transparent, thermally conductive plate 314 or 324; a quarter-wave plate 313 or 323, and an optional protective glass cover (not shown) on the outside of quarter-wave plates 313 or 323. In circular polarizers, the fast axes of quarter-wave plates 313 and 323 are oriented relative to the respective polarization axes of linear polarizers 312 and 322, as previously described (this is also true for the corresponding components in each of the embodiments shown in FIGS. 4 and 5 below). Since the circular polarizer stacks 310 and 320 have the same structures with corresponding components, discussions relating to one or more components in one stack will also apply to the other stack.

Referring back to the polarizer stack 210 of FIG. 2, the energy absorbed by polarizer 212 at hot spot 231 is conducted through the thickness of layer 211, 212, and 213, and radially within each layer. However, since the linear polarizer 212, being made of plastic, is a poor thermal conductor, the radial heat transfer (upward towards the outer body of lens system 200, or downward towards septum 205) in 212 is poor. Instead, more heat energy is transferred axially to glass cover 211 and quarter-wave plate 213. Since quarter-wave plate 213, often made of plastic, is also a poor heat conductor, most of the heat carried away from hot spot 231 is conducted into glass cover 211, and then transferred radially to the body of lens system 200 (potentially including septum 205), and to the air between element 203 and glass cover 211, eventually reaching the body of lens system 200 by convection.

As shown in FIG. 2 and FIG. 3A, the bottoms of polarizer stacks 210, 310 and the tops of polarizer stacks 220, 320 are each separated from the septum 205 by a gap. In other embodiments, the polarizer stacks can be in physical contact with the septum 205 to improve heat conduction. Furthermore, at least the lenses can be configured to have a flat edge proximate to or contacting the septum 205. With the lenses having flat edges close to the septum, the optical axes can be located closer to the septum 205 than otherwise would be if the lenses have conventional curved edges. Such a configuration can be particularly useful if the lenses are designed to have larger diameters to allow more light to pass through. This is illustrated in FIG. 3B, which shows lenses 203 and 204 each having a flat edge proximate the septum 205, as viewed along an axial direction, i.e., along the light rays 251, 252. Although the optical axes are defined by the lenses, and will not be affected by flat edges on the polarizers or quarter-wave plates, it is still preferable, in practice, to have flat edges for these other optical elements.

In stack 310 of the present invention, the presence of thermally conductive layer 314 between the linear polarizer 312 and quarter-wave plate 313, and in contact with at least the linear polarizer 312 (can also be in contact with both polarizer 312 and quarter-wave plate 313), provides an additional conduction path for hot spot 331, i.e., axially to layer 314 and then radially to the lens body. Layer 314, which is also in physical contact with the lens body (not shown), provides an improved radial conductive path to the body of lens system 300, as long as layer 314 has a higher thermal conductivity than both the birefringent material forming quarter-wave plate 313 and linear polarizer 312. Suitable materials for layers 314 and 324 include Schott Robax, a glass having a thermal conductivity of 1.6 W/mK (watts per milliKelvin), fused quartz products such as Suprasil by Heaeus of Germany, having conductivity from 1.6-2.0 W/mK, and other glasses with comparable or better thermal properties. Note that regular glass has a thermal conductivity of about 1.1 W/mK. In one example, a solid material layer that is optically transparent, and having a thermal conductivity of at least 1.5 W/mK is used. An optically clear layer of diamond, with its extremely high thermal conductivity at 2000 W/mK, would be a good choice if cost is not an issue. In general, the thermally conductive layer 314 should be sufficiently transparent to light used for projecting the stereoscopic images.

The polarizer stacks 310 and 320 can be laminated in bulk and then cut as a unit, which would maximize the thermal contact between adjacent layers or elements in each stack. This configuration would result in the polarizers, quarter-wave plates and other layers or elements in the stack having the same shape or size (e.g., circular and/or with flat edge). As previously mentioned, elements of the polarizer stacks can also be in contact with the septum 205.

The thickness of layer 314 may also be increased to provide a larger cross-sectional area through which heat can be conducted towards the body of lens system 300. Furthermore, the thickness of glass layer 311 can similarly be increased to improve the radial heat transport rate, though the axial heat transfer rate will be reduced in roughly the same proportion. In prior art systems, glass layers such as 311 have ranged from 1.5 mm to 3.3 mm. A thickness greater than 3.3 mm for the thermally conductive layers 314 and 324 is desirable, though it is not required because of the improved thermal conductivity. The thickness of respective layers 314 and 324 can vary according to specific design requirements, but should not mechanically interfere with lenses 203 or 204, or extend too far as to no longer subtend its associated volume 253 or 254, or interfere with the “opposite” volume 254 or 253 (i.e., the volume associated with other half of the projection system). As an example, a thickness of less than about 20 mm may be a reasonable upper limit for layer 314 or 324.

FIG. 4 shows lens system 400 with improved right- and left-eye circular polarizer stacks 410 and 420, each includes, respectively, glass cover 411 or 421; linear polarizer 412 or 422; air gap 415 or 425; quarter-wave plate 413 or 423; and an optional protective glass cover plate 417 or 427. Again, due to the similar structures and components in stacks 410 and 420, any discussion of one stack will also apply to the other stack.

In this case, in addition to conduction by respective glass layer 411 and 421 (similar to the example of FIG. 3), heat from hot spots 419 and 429 is also transferred respectively to the air in gaps 415 or 425, and then via convection to the body of lens system 400. A wider air gap (i.e., larger separation between linear polarizer and its associated quarter-wave plate) can increase convection current and improve heat transport. Such a gap can also be filled with other fluids with appropriate thermal, optical and chemical properties compatible with system designs. Since the fluid facilitates heat transport primarily by convection, it is not required that its thermal conductivity be greater than that of the linear polarizer that it is in contact with (or the quarter-wave plate), although a fluid having a larger thermal conductivity than that of the polarizer can further improve heat transport by conduction. In general, the plastic elements in a polarizer have relatively poor thermal conductivity.

Aside from air, other gases or mixtures including at least one of: nitrogen, oxygen, inert gases and helium, among others, may also be used. If desired, the gap between the linear polarizer and the quarter-wave plate may be provided as an enclosed space, especially for use with a liquid with suitable properties. For example, a non-reactive fluid with a lower viscosity and higher thermal conductivity would be a good candidate for improving heat transport. A fluid-filled gap (which can also be considered as a material layer) as small as 0.5 mm may be used. In addition, the fluid can also be provided as a liquid or gaseous flow stream (closed or open loop) for enhanced heat transfer, e.g., at a flow rate that is effective for improved heat transfer, but without causing adverse effect on light propagation. For example, circulating air can be filtered and dried to minimize the risk of contamination and condensation.

Furthermore, at least one of the following features or elements can be used, e.g., heat transfer components such as copper braids 416 and 426, an array of vanes or fins (not shown), or some other surface treatment or attachment to the lens body or septum, to enhance heat transfer from the air in gaps 415 and 425 to the body of lens system 400 (or septum 205). Aside from copper braids (or other forms such as copper wool, ribbons, strips, and so on), other metals including aluminum, brass, or others with similar or better thermal conductivity can also be used. It is preferable that the materials be corrosion-resistant to the heat transfer fluid or potential impurities. Certain new materials such as nano-materials may also be suitable, e.g., carbon nanotubes, which has a theoretical thermal conductivity of 800-6000 W/mK. Heat transfer between the lens body (typically made of metal) and the air gap can be improved by increasing the surface area for heat transfer, by modifying surfaces with enhanced thermal conduction properties, or a combination. However, care must be taken that copper braids 416 and 426 or other heat transfer enhancing features surrounding air gaps 415 and 425 remain outside of volumes 253 and 254 so as to avoid vignetting the corresponding projected images. In fact, in any embodiment, the perimeters of the elements of stacks 210, 220, 310, 320, 410, 420, 510, and 520 (the latter from FIG. 5) should remain outside of volumes 253 and 254, to avoid possible vignetting.

In still another embodiment, shown in FIG. 5, lens system 500 has improved right- and left-eye circular polarizer stacks 510 and 520, each stack includes, respectively, glass cover 511 or 521; linear polarizer 512 or 522; a transparent, thermally conductive plate 514 or 524; an air gap (or fluid-filled gap) 515 or 525; quarter-wave plate 513 or 523, and an optional protective glass cover plate 517 or 527. In general, the thermally conductive plates 514, 524 can be any suitable solid layer with properties (e.g., optical, thermal, chemical and mechanical) that are compatible with system design needs, and instead of air, other fluids with suitable properties can also be used in gaps 515, 525. The thermally conductive layer and the fluid-filled gap can also be referred to as a heat transport medium.

In this case, heat from hot spots 531 and 532 is conducted away by glass layers 511 and 521 in one direction, and by thermally conductive plates (e.g., glass plates) 514 and 524 in the other, as previously discussed for FIG. 3. In addition, glass plates 514 and 524 will further transfer heat to the fluid in respective fluid-filled gaps 515 and 525, which can, in turn, transfer heat to the body of lens system 500 by convection. In this embodiment where both a thermally conductive layer (e.g., 514, 524) and a fluid-filled gap (e.g., 515, 525, which can be provided as a static or a flow arrangement) are present between the polarizer and the quarter-wave plate, it is desirable that the layer or gap with a larger heat-transfer rate be located adjacent to, and in contact with, the linear polarizer. As in FIG. 4, the heat transfer to the body of lens 100 or the septum 103 can be enhanced by copper braids 516 and 526 or other heat transfer enhancement as discussed, without intruding on volumes 253 and 254, respectively.

Since the hot spots are located off-center with respect to the elements of the polarizer stacks, i.e., closer to the septum, it will be desirable to provide more cooling near the septum. For example, additional thermal conductive elements can be provided near the septum than farther away from the septum. A circulating fluid can be configured with a flow pattern for directing heat away from the septum, e.g., towards the lens body. Such a fluid can include air or other gases, which should be properly dried to avoid condensation on the optical elements. Note that for an upper-lower dual lens system such as that in FIG. 1, a fluid with a positive coefficient of thermal expansion (i.e., becomes less dense at higher temperature) will transport heat by convection towards the septum for lower filter 322, but away from the septum for upper filter 312.

In another embodiment, any of the elements of stacks 210, 220, 310, 320, 410, 420, 510, and 520 can be thermally coupled to the body of lens system, septum, and any other intervening structures (not shown) with a thermal conductivity enhancing material, such as: the copper braids (or copper wool) 416, 426, 516, and 526 or surface treatments; a thermal grease such as those used in microprocessor heat sinks (e.g., beryllium oxide powder suspended in a silicone compound having an thermal conductivity of over 200 W/mK), or thermal conducting epoxy (for example, Aremco-Bond 556 silver flake filled epoxy, made by Aremco Products of Valley Cottage, N.Y.).

In still another embodiment, adjacent elements within stacks 210, 220, 310, 320, 410, 420, 510, and 520 may be cemented with lens cement having a high thermal conductivity to improve heat transfer.

One or more features of the embodiments discussed above can be adapted for use in different projection systems for film-based or digital 3D presentations.

While the forgoing is directed to various embodiments of the present invention, other and further embodiments of the invention may be devised without departing from the basic scope thereof. As such, the appropriate scope of the invention is to be determined according to the claims, which follow.

What is claimed is:

1. A system for transmitting stereoscopic images for three-dimensional (3D) projection, comprising:
a lens body surrounding a first lens assembly and a second lens assembly;
the first lens assembly configured for projecting a first image of a stereoscopic image pair, and the second lens assembly configured for projecting a second image of the stereoscopic image pair; and
at least one of the first lens assembly and the second lens assembly comprises:
a lens element;
a linear polarizer;
a quarter-wave plate; and
at least one material layer between the linear polarizer and the quarter-wave plate for removing heat from the linear polarizer.

2. The system of claim 1, wherein the at least one material layer includes at least one of: a thermally conductive solid and a fluid.

3. The system of claim 1, whether the at least one material layer includes a thermally conductive solid and a fluid.

4. The system of claim 2, wherein the fluid includes at least one of: air, nitrogen, oxygen and helium.

5. The system of claim 2, wherein the linear polarizer and the quarter-wave plate are separated at a distance of at least 0.5 mm by the fluid.

6. The system of claim 2, wherein the thermally conductive solid has a thickness greater than 3.3 mm.

7. The system of claim 2, wherein the at least one material layer is transparent to light used for projecting the stereoscopic images.

8. The system of claim 2, wherein the thermally conductive solid has a thermal conductivity of at least 1.5 W/mK.

9. The system of claim 2, wherein the at least one material layer has a higher thermal conductivity than the linear polarizer and the quarter-wave plate.

10. The system of claim 1, further comprising a thermally conductive component for enhancing heat transfer between the at least one material layer and the lens body.

11. The system of claim 10, wherein the thermally conductive component is in contact with the lens body, and includes at least one of: copper, thermally conductive grease and thermally conductive epoxy.

12. A method for transmitting stereoscopic images for three-dimensional (3D) projection, comprising:
directing a first set of images through a first lens assembly that includes at least a first linear polarizer, a first quarter-wave plate, and at least a first material layer between the first linear polarizer and the first quarter-wave plate for removing heat from the first linear polarizer;
directing a second set of images through a second lens assembly that includes at least a second linear polarizer, a second quarter-wave plate, and at least a second material layer between the second linear polarizer and the second quarter-wave plate for removing heat from the second linear polarizer;
configuring the first linear polarizer and the first quarter-wave plate to impart a first circular polarization orientation to the first set of images; and
configuring the second linear polarizer and the second quarter-wave plate to impart a second circular polarization orientation to the second set of images.

13. The method of claim 12, wherein the first circular polarization orientation is orthogonal to the second circular polarization orientation.

14. The method of claim 12, further comprising:
including at least one of: a thermally conductive solid and a fluid in the first material layer; and
including at least one of: a thermally conductive solid and a fluid in the second material layer.

15. The method of claim 14, wherein the thermally conductive solid has a thermal conductivity of at least 1.5 W/mK.

16. The method of claim 14, wherein the fluid wherein the fluid includes at least one of: air, nitrogen, oxygen and helium.

17. The method of claim 14, further comprising:
providing a thermally conductive component to enhance heat transfer between the thermally conductive solid and a lens body surrounding the first lens assembly and the second lens assembly.

18. The method of claim 17, further comprising:
providing contact between the thermally conductive component and the lens body;
wherein the thermally conductive component includes at least one of: copper, thermally conductive grease and thermally conductive epoxy.
